(19) United States
(12) Patent Application Publication
(10) Pub. No.: US 2010/0314961 A1
(43) Pub. Date: Dec. 16, 2010

(54) MAGNETIC FLUX SWITCHING TYPE ELECTRIC GENERATOR USING SHIELDING MEMBER AS PERMANENT MAGNET

(76) Inventors: Jong-suk An, Daejeon (KR); Byeong-Moon Kim, Daejeon (KR)

Correspondence Address: CANTOR COLBURN LLP, 20 Church Street, 22nd Floor, Hartford, CT, 06103, US

(21) Appl. No.: 12/740,545

(22) PCT Filed: Oct. 24, 2008
(86) PCT No.: PCT/KR2008/006291

§ 371 Date: May 3, 2010

(30) Foreign Application Priority Data
Oct. 29, 2007 (KR) 10-2007-0108905

(51) Int. Cl. H02K 21/38; H02K 21/24

(52) U.S. Cl. 310/155; 310/156.35

(57) ABSTRACT

Disclosed is a magnetic flux switching type electric generator using a shielding member as a permanent magnet in that a magnet is fixed and a shielding member is formed at a passing portion of the magnetic flux, so that the magnetic flux is repeatedly opened and blocked through a continuous revolution or a repeated motion of the shielding member to generate induced electricity, whereby the amount of generation of electric power can be more and more increased. The magnetic flux switching type electric generator comprises: a pair of coil cores arranged on both sides thereof and having coils wound thereon respectively; a magnet connected to the pair of coil cores having the wound coils and allowing the coil cores to be polarized as a north pole and a south pole respectively; and a shielding member formed at a passing portion of the magnetic flux between the pair of the coil cores having the coils arranged on both sides thereof, wherein the magnetic flux is repeatedly opened and blocked through a repeated motion of the shielding member to bring about a change of a magnetic field, whereby generating induced electricity.

### TECHNICAL FIELD

The present invention relates to a magnetic flux switching type electric generator using a shielding member as a permanent magnet, and more particularly to a magnetic flux switching type electric generator using a shielding member as a permanent magnet in that a magnet is fixed and a shielding member is formed at a passing portion of the magnetic flux, so that the magnetic flux is repeatedly opened and blocked through a continuous revolution or a repeated motion of the shielding member, whereby generating induced electricity.

### BACKGROUND ART

Generally, a conventional electric generator includes a stator winding coil core and a rotating magnet. The rotating magnet is rotated, so that the magnetic pole is changed, thereby generating the electricity of an AC (alternating current).

However, in the conventional electric generator, since the size of the rotating magnet is large, there are problems in that the amount of the heat generation is larger and more energy is used up owing to the revolution of the big rotating magnet, thereby the amount of generation of electric power can be remarkably deteriorated in comparison with the inputted values to bring about the nonproductiveness thereof.

### DISCLOSURE OF INVENTION

### Technical Problem

Accordingly, the present invention has been made to solve the above-mentioned problems occurring in the prior art, and an object of the present invention is to provide to a magnetic flux switching type electric generator using a shielding member as a permanent magnet in that a shielding member is formed at a passing portion of the magnetic flux, so that the magnetic flux is repeatedly opened and blocked through a continuous revolution or a repeated motion of the shielding member to bring about the change of the magnetic pole, whereby generating the electric power.

### Technical Solution

To accomplish the objects, the present invention provides a magnetic flux switching type electric generator using a shielding member as a permanent magnet comprising: a pair of coil cores arranged on both sides thereof and having coils wound thereon respectively; a magnet connected to the pair of coil cores having the wound coils and allowing the coil cores to be polarized as a north pole and a south pole respectively; and a shielding member formed at a passing portion of the magnetic flux between the pair of the coil cores having the coils arranged on both sides thereof, wherein the magnetic flux is repeatedly opened and blocked through a repeated motion of the shielding member to bring about a change of a magnetic field, whereby generating induced electricity.

To accomplish the objects, the present invention provides a magnetic flux switching type electric generator using a shielding member as a permanent magnet comprising: a pair of coil cores arranged on both sides thereof and having coils wound thereon respectively; a magnet connected to the pair of coil cores having the wound coils and allowing the coil cores to be polarized as a north pole and a south pole respectively; at least one shielding member formed at a passing portion of the magnetic flux between the pair of the coil cores having the coils for polarizing the north or south poles respectively; and ferrite members located between the shielding members and continuously connected to the magnet, wherein the magnetic flux is repeatedly opened and blocked through a repeated motion of the shielding member to bring about a change of a magnetic field, whereby generating induced electricity.

To accomplish the objects, the present invention provides a magnetic flux switching type electric generator using a shielding member as a permanent magnet comprising: a saw-toothed rotating magnetic body; a plurality of coil cores arranged along a peripheral of the saw-toothed rotating magnetic body having upper and lower coils wound thereon respectively; and a magnet connected to the plurality of the coil cores having the wound coils and allowing the upper and lower coils to be polarized as a north pole and a south pole respectively, wherein a magnetic flux is repeatedly opened and blocked through a revolution of the saw-toothed rotating magnetic body to bring about a change of a magnetic field, whereby generating induced electricity.

Preferably, the shielding member is a saw-toothed rotating magnetic body and the rotating magnetic body is rotated, so that the magnetic flux is repeatedly opened and blocked through a repeated motion thereof to bring about the change of the magnetic field, whereby generating induced electricity.

Preferably, the shielding member is a bisymmetry magnetic body of a bar type and the magnetic flux is repeatedly opened and blocked through a repeated motion of the bisymmetry magnetic body of the bar type to bring about the change of the magnetic field, whereby generating induced electricity.

Preferably, the rotating magnetic body comprises a nonmetal circular plate having a rotating axis and a plurality of saw-toothed portions formed at a circumference of the nonmetal circular plate and having a N-polar upper portion and a S-polar lower portion thereof or a S-polar upper portion and a N-polar lower portion thereof.

Preferably, the rotating magnetic body comprises a nonmetal circular plate having a rotating axis, a plurality of saw-toothed portions formed at a circumference of the nonmetal circular plate and having a N-polar upper portion and a S-polar lower portion thereof or a S-polar upper portion and a N-polar lower portion thereof, and a plurality of magnetic bodies inserted into empty spaces between the saw teeth and having another S-polar upper portion and N-polar lower portion thereof corresponding to the N-polar upper portion and S-polar lower portion of the saw-toothed portions or another N-polar upper portion and S-polar lower portion thereof corresponding to the S-polar upper portion and N-polar lower portion of the saw-toothed portions.

Preferably, the rotating magnetic body comprises a nonmetal circular plate having a rotating axis, a plurality of saw-toothed portions formed at the circumference of the nonmetal circular plate and having a N-polar upper portion and a S-polar lower portion thereof or a S-polar upper portion and a N-polar lower portion thereof, and a plurality of ferrites or cores inserted into empty spaces between the saw teeth, whereby the flux of the magnetic force thereof can be increased.

Preferably, where the number of the coil cores having the wound coils is an even number, the number of the saw teeth formed at the peripheral of the saw-toothed rotating magnetic body is an odd number.

Preferably, the rotating magnetic body comprises a nonmetal circular plate having a rotating axis and a plurality of saw-toothed portions formed at a circumference of the nonmetal circular plate and having a N-polar upper portion and a S-polar lower portion thereof or a S-polar upper portion and a N-polar lower portion thereof, a N-polar portion of the magnet being located at an upper portion thereof in case of the N-polar upper portion and S-polar lower portion of the saw-toothed portion and a S-polar portion of the magnet being located at the upper portion thereof in case of the S-polar upper portion and the N-polar lower portion of the saw-toothed portion.

### ADVANTAGEOUS EFFECTS

As can be seen from the foregoing, in the magnetic flux switching type electric generator using a shielding member as a permanent magnet, there are superior effects in that the shielding member is formed at the passing portion of the magnetic flux, so that the magnetic flux is repeatedly opened and blocked through a continuous revolution or a repeated motion of the shielding member to bring about the change of the magnetic pole, whereby generating the electric power.

Accordingly, it can overcome the problem on the generation of electric power and the inefficiency generated from the conventional art, whereby the amount of generation of electric power can be more and more increased.

That is, the magnetic flux can be opened and blocked through the permanent magnet, whereby the amount of generation of electric power can be more and more increased without disturbing by the counter electromotive force.

### BRIEF DESCRIPTION OF DRAWINGS

The above as well as the other objects, features and advantages of the present invention will be more apparent from the following detailed description taken in conjunction with the accompanying drawings, in which:

FIG. 1 is a schematic perspective view illustrating a magnetic flux switching type electric generator using a shielding member as a permanent magnet according to a first embodiment of the present invention;

FIG. 2 is a sectional view illustrating a magnetic flux switching type electric generator using a shielding member as a permanent magnet according to a first embodiment of the present invention;

FIG. 3 is a schematic perspective view illustrating a rotating magnetic body of a magnetic flux switching type electric generator using a shielding member as a permanent magnet according to the first embodiment of the present invention;

FIG. 4 is a schematic sectional view illustrating an example in that a magnetic force is passed through a magnetic flux switching type electric generator using a shielding member as a permanent magnet according to the first embodiment of the present invention;

FIG. 5 is a schematic sectional view illustrating an example that a magnetic force is not passed through a magnetic flux switching type electric generator using a shielding member as a permanent magnet according to the first embodiment of the present invention;

FIG. 6 is a sectional view illustrating a magnetic flux switching type electric generator using a shielding member as a permanent magnet according to a second embodiment of the present invention;

FIG. 7 is a schematic perspective view illustrating a magnetic flux switching type electric generator using a shielding member as a permanent magnet according to a third embodiment of the present invention; and

FIG. 8 is a sectional view illustrating a magnetic flux switching type electric generator using a shielding member as a permanent magnet according to a fourth embodiment of the present invention.

### BEST MODE FOR CARRYING OUT THE INVENTION

A preferred embodiment of the invention will be described in detail below with reference to the accompanying drawings.

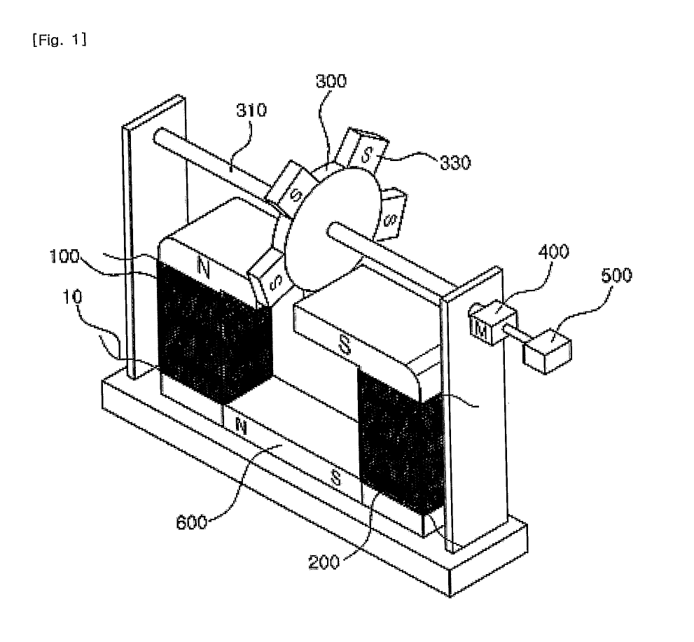

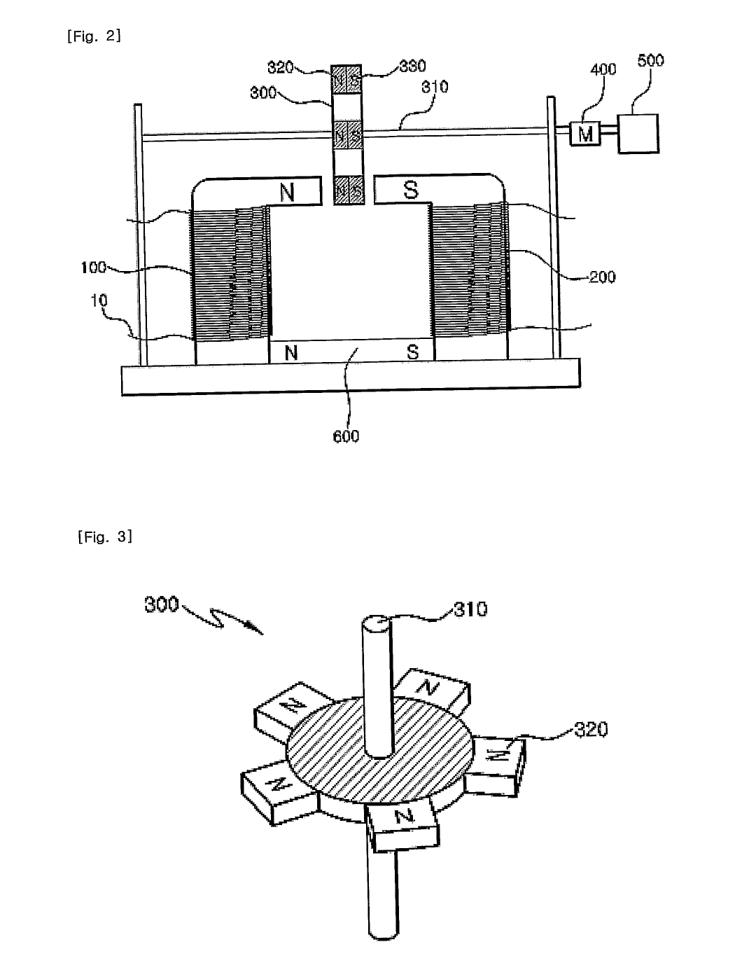

FIG. 1 is a schematic perspective view illustrating a magnetic flux switching type electric generator using a shielding member as a permanent magnet according to a first embodiment of the present invention and FIG. 2 is a sectional view illustrating a magnetic flux switching type electric generator using a shielding member as a permanent magnet according to a first embodiment of the present invention.

As shown in the drawings, the magnetic flux switching type electric generator using a shielding member as a permanent magnet according to the first embodiment of the present invention includes a pair of coil cores arranged on both sides 100 and 200 thereof and having coils wound thereon respectively, a magnet 600 connected to the pair of coil cores having the wound coils and allowing the coil cores to be polarized as a north pole and a south pole respectively, and a shielding member 300 formed at a passing portion of the magnetic flux between the pair of the coil cores having the coils arranged on both sides 100 and 200 thereof. Here, the magnetic flux is repeatedly opened and blocked through a repeated motion of the shielding member 300 to bring about the change of the magnetic field, whereby generating induced electricity.

Here, the shielding member 300 includes a saw-toothed rotating magnetic body. The rotating magnetic body is rotated, so that the magnetic flux is repeatedly opened and blocked through a repeated motion thereof to bring about the change of the magnetic field, whereby generating induced electricity.

That is, for example, the magnetic flux switching type electric generator using a shielding member as a permanent magnet according to the first embodiment of the present invention includes the pair of coil cores arranged on both sides 100 and 200 thereof and having coil wound thereon respectively, a N-polar portion of the magnet located at the left coil core for polarizing the north pole, a S-polar portion of the magnet located at the right coil core for polarizing the south pole, and the shielding member 300 formed at a passing portion of the magnetic flux between the pair of the coil cores having the coils arranged on both sides 100 and 200 thereof.

Here, as shown in the drawings, where the magnets 600 is continuously connected to the pair of coil cores having the wound coils, the N-polar portion of the magnet is arranged at the left coil core. However, the S-polar portion of the magnet can be arranged at the left coil core. In this case, the N-polar portion of the magnet must be arranged at the right coil core so as to form the magnetic flux between them.

Here, since the operation principles of the electric generator are already well-known in public, further description on this is omitted here.

In order to increase the effects of the magnetic induction currents, it is preferred that the left and right coils are made of an undirected ferrite. Accordingly, the eddy current is not generated from the rotating magnetic body, so that the generation of the currents can be increased.

Therefore, the magnetic flux can be opened and blocked through the shielding member and the permanent magnet, so that it is free from the counter electromotive force.

FIG. 3 is a schematic perspective view illustrating a rotating magnetic body of a magnetic flux switching type electric generator using a shielding member as a permanent magnet according to the first embodiment of the present invention.

As shown in FIG. 3, the saw-toothed rotating magnetic body 300 is rotated, so that the magnetic flux is repeatedly opened and blocked through the repeated motion thereof to bring about the change of the magnetic field, whereby generating the induced electricity.

The rotating magnetic body according to the present invention includes a nonmetal circular plate having a rotating axis 310 and a plurality of saw-toothed portions formed at the circumference of the nonmetal circular plate and having a N-polar upper portion and a S-polar lower portion thereof or a S-polar upper portion and a N-polar lower portion thereof.

According to another aspect of the present invention, the rotating magnetic body includes a nonmetal circular plate having a rotating axis 310, a plurality of saw-toothed portions formed at the circumference of the nonmetal circular plate and having a N-polar upper portion and a S-polar lower portion thereof or a S-polar upper portion and a N-polar lower portion thereof, and a plurality of magnetic bodies inserted into empty spaces between the saw teeth and having another S-polar upper portion and N-polar lower portion thereof corresponding to the N-polar upper portion and S-polar lower portion of the saw-toothed portions or another N-polar upper portion and S-polar lower portion thereof corresponding to the S-polar upper portion and N-polar lower portion of the saw-toothed portions.

Accordingly, the plurality of magnetic bodies having a different polarity is formed at the empty spaces between the saw teeth, so that the flux of the magnetic force thereof can be increased.

According to further another aspect of the present invention, the rotating magnetic body includes a nonmetal circular plate having a rotating axis 310, a plurality of saw-toothed portions formed at the circumference of the nonmetal circular plate and having a N-polar upper portion and a S-polar lower portion thereof or a S-polar upper portion and a N-polar lower portion thereof, and a plurality of ferrites or cores inserted into empty spaces between the saw teeth, thereby the flux of the magnetic force thereof can be increased.

Also, a plurality of gaps between the corresponding magnets is closely formed and a plurality shielding members is formed at each gap, so that it can more effectively generate the magnetic force.

So to explain the operating principles thereof, the rotating axis 310 of the rotating magnetic body is connected to a driving motor 400 and a power 500 is electrically connected to the driving motor 40, so that the rotating axis 310 and the rotating magnetic body can be rotated through the revolution of the driving motor 400 of receiving the sources of electricity from the power 500.

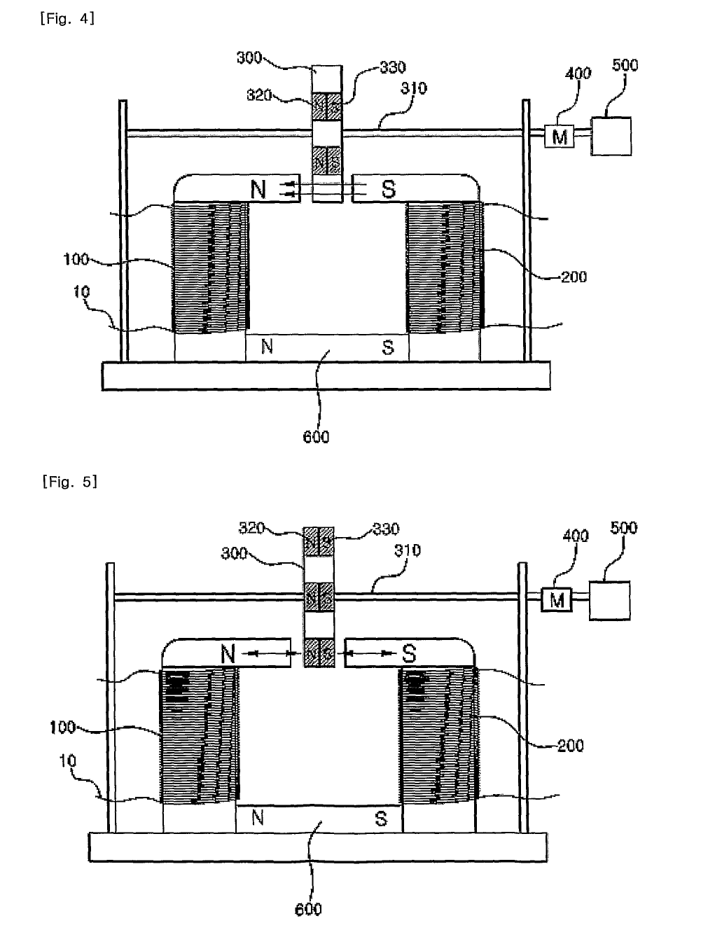

FIG. 4 is a schematic sectional view illustrating an example in that a magnetic force is passed through a magnetic flux switching type electric generator using a shielding member as a permanent magnet according to the first embodiment of the present invention.

FIG. 5 is a schematic sectional view illustrating an example that a magnetic force is not passed through a magnetic flux switching type electric generator using a shielding member as a permanent magnet according to the first embodiment of the present invention.

As shown in FIG. 4, where the magnet is paralleled with peripheral portions of the nonmetal circular plate of the rotating magnetic body in that the saw teeth are not formed, the magnetic force is passed from the S-polar portion 330 to the N-polar portion thereof.

Also, as shown in FIG. 5, where the magnet is paralleled with the saw teeth of the nonmetal circular plate of the rotating magnetic body according to the revolution of the rotating magnetic body 300, the magnetic force passed from the S-polar portion 330 to the N-polar portion thereof is blocked.

Accordingly, the above processes are continuously repeated, so that the electric power is generated in the output terminals (ending portion of the coils).

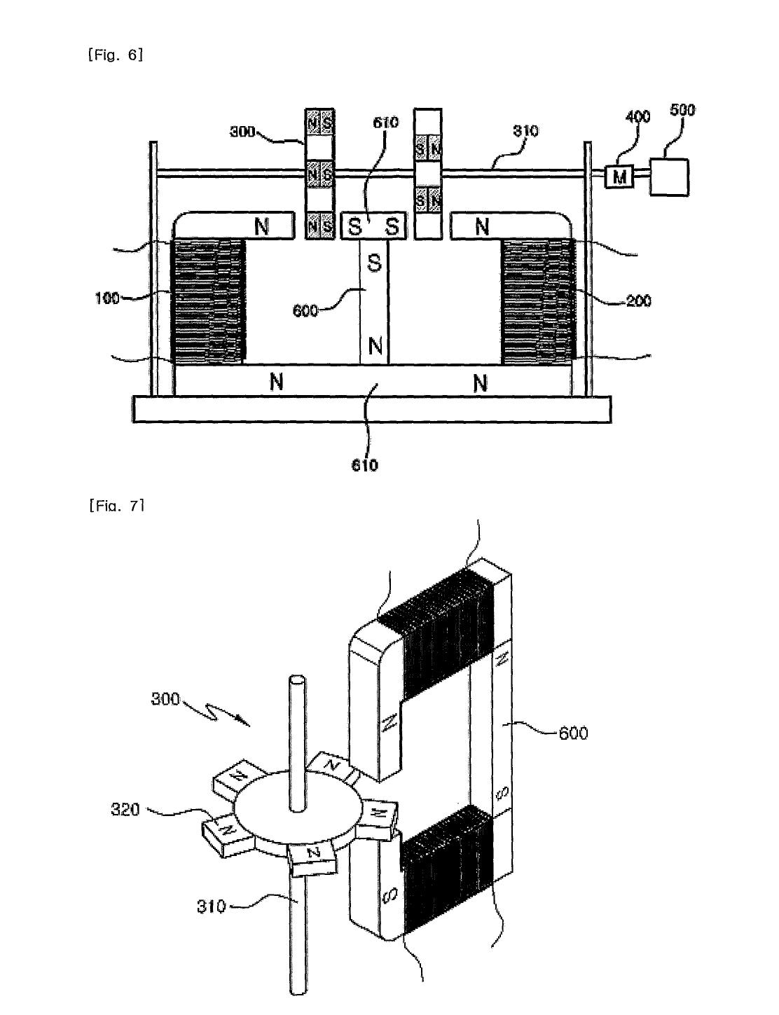

FIG. 6 is a sectional view illustrating a magnetic flux switching type electric generator using a shielding member as a permanent magnet according to a second embodiment of the present invention.

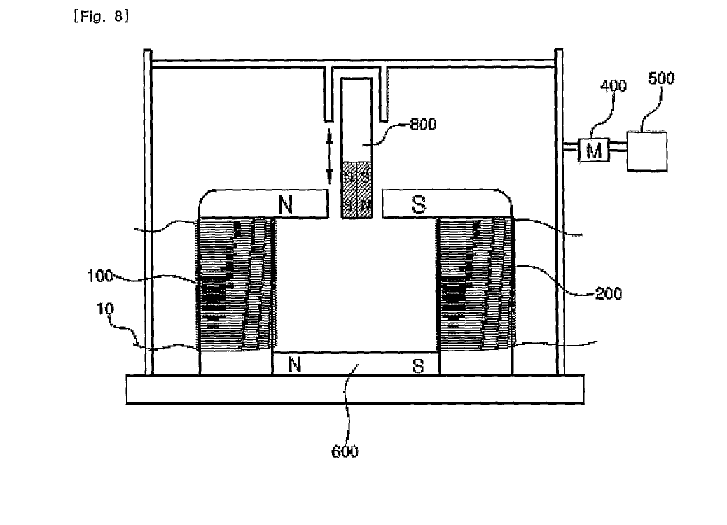

FIG. 8 is a sectional view illustrating a magnetic flux switching type electric generator using a shielding member as a permanent magnet according to a fourth embodiment of the present invention.

As shown in FIG. 6, the magnetic flux switching type electric generator using a shielding member as a permanent magnet according to the second embodiment of the present invention includes a pair of coil cores arranged on both sides 100 and 200 thereof and having coils wound thereon respectively, magnets 600 connected to the pair of coil cores having the wound coils and allowing the coil cores to be polarized as a north pole and a south pole respectively, at least one shielding member 300 formed at a passing portion of the magnetic flux between the pair of the coil cores having the coils for polarizing the north or south poles respectively arranged on both sides 100 and 200 thereof, and ferrite members 610 located between the shielding members 300 and continuously connected to the magnet 600. Here, the magnetic flux is repeatedly opened and blocked through a repeated motion of the shielding member 300 to bring about the change of the magnetic field, whereby generating induced electricity.

More concretely, if the saw teeth of the left shielding member 300 are located between the S-polar portion and N-polar portion of the magnet 600, the right shielding member 300 is rotated in order that the empty space, in that the saw teeth thereof are not formed, is located between them.

Two shielding members 300 are formed in FIG. 6. However, at least two shielding members 300 can be formed as occasion demands.

Here, the magnetic flux is blocked in the left shielding member 300 and the magnetic flux is opened in the right shielding member 300. Also, the reverse is the same.

Also, the ferrite members 610 formed at upper and lower portions of the middle magnet 600 serves to polarize the adjacent polarities. That is, where the upper portion of the middle magnet 600 polarizes the south pole, the upper ferrite member 610 becomes the south pole and the lower ferrite member 610 becomes the north pole.

Moreover, the pair of coil cores having the coils wound thereon are arranged on both sides of the lower ferrite portion 610. Here, where the lower ferrite portion 610 is the north pole, the pair of coil cores having the coils wound thereon arranged on both sides thereof also, polarize the north pole.

According to the magnetic flux switching type electric generator using a shielding member as a permanent magnet of the second embodiment of the present invention, the flux of the magnetic force thereof can be magnified.

As shown in FIG. 8, the shielding member of the magnetic flux switching type electric generator using a shielding member as a permanent magnet according to the fourth embodiment of the present invention includes a bisymmetry magnetic body 800 of a bar type. That is, the magnetic flux is repeatedly opened and blocked through a repeated motion of the bisymmetry magnetic body 800 of the bar type to bring about the change of the magnetic field, whereby generating induced electricity.

More concretely, firstly, one coil core having the coil of the north pole connected to the N-polar magnet is located at the left side thereof and another coil core having the coil of the south pole connected to the S-polar magnet is located at the right side thereof. Then, the bisymmetry magnetic body 800 is located between them. Here, when a S-polar portion and a N-polar portion are formed at the left and right sides of the lower portion of the bisymmetry magnetic body 800 respectively, the magnetic field is opened, thereby applying the electric currents. On the contrary, the N-polar portion and the S-polar portion are formed at the left and right sides of the lower portion of the bisymmetry magnetic body 800 respectively, the magnetic field is blocked, thereby the electric currents is not applied.

In order to vertically go and return the bisymmetry magnetic body 800 of the bar type, a magnetic device is connected to the bisymmetry magnetic body 800. Since the magnetic device for vertically going and returning the bisymmetry magnetic body 800 of the bar type is widely well-known in public, the descriptions on the construction and operating principle thereof are omitted here.

FIG. 7 is a schematic perspective view illustrating a magnetic flux switching type electric generator using a shielding member as a permanent magnet according to a third embodiment of the present invention.

As shown in FIG. 7, the magnetic flux switching type electric generator using a shielding member as a permanent magnet according to the third embodiment of the present invention includes a saw-toothed rotating magnetic body 300, a plurality of coil cores arranged along the peripheral of the saw-toothed rotating magnetic body having upper and lower coils wound thereon respectively, and a magnet 600 connected to the plurality of the coil cores having the wound coils and allowing the upper and lower coils to be polarized as a north pole and a south pole respectively. Here, the magnetic flux is repeatedly opened and blocked through a revolution of the saw-toothed rotating magnetic body 300 to bring about the change of the magnetic field, whereby generating induced electricity.

Here, where the number of the coil cores having the wound coils is an even number, the number of the saw teeth formed at the peripheral of the saw-toothed rotating magnetic body 300 is an odd number.

On the contrary, where the number of the coil cores having the wound coils is an odd number, the number of the saw teeth formed at the peripheral of the saw-toothed rotating magnetic body 300 is an even number.

That is, if the number of the coil cores having the wound coils is an add number and the number of the saw teeth of the saw-toothed rotating magnetic body 300 is also, an add number, since it maintains the balance of the power, there is a problem in that it is necessary to supply more electricity to it for the operation thereof. Accordingly, in order to upset the balance between them, as described above, if the number of the coil cores is an even number, the number of the saw teeth formed at the peripheral of the saw-toothed rotating magnetic body 300 is an odd number. Also, if the number of the coil cores having the wound coils is an add number, the number of the saw teeth formed at the peripheral of the saw-toothed rotating magnetic body 300 is an even number, whereby magnifying the efficiency of the revolution thereof.

The rotating magnetic body includes a nonmetal circular plate having a rotating axis 310 and a plurality of saw-toothed portions formed at the circumference of the nonmetal circular plate and having a N-polar upper portion and a S-polar lower portion thereof or a S-polar upper portion and a N-polar lower portion thereof. Here, where the saw-toothed portion is the N-polar upper portion and the S-polar lower portion, the N-polar portion of the magnet is located at the upper portion of the saw-toothed portion f or polarizing the upper coils as the north pole. On the contrary, where the saw-toothed portion is the S-polar upper portion and the N-polar lower portion, the S-polar portion of the magnet is located at the upper portion of the saw-toothed portion for polarizing the upper coils as the south pole.

The construction of the coil cores having the wound coils is the same as that of the first embodiment of the present invention, except that it is vertically turned.

Accordingly, the magnetic flux is repeatedly opened and blocked through the repulsive force of the poles, whereby generating induced electricity.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

### INDUSTRIAL APPLICABILITY

As can be seen from the foregoing, in the magnetic flux switching type electric generator using a shielding member as a permanent magnet, there are superior effects in that the shielding member is formed at the passing portion of the magnetic flux, so that the magnetic flux is repeatedly opened and blocked through a continuous revolution or a repeated motion of the shielding member to bring about the change of the magnetic pole, whereby generating the electric power. Accordingly, it can overcome the problem on the generation of electric power and the inefficiency generated from the conventional art, whereby the amount of generation of electric power can be more and more increased.

1. A magnetic flux switching type electric generator using a shielding member as a permanent magnet comprising:
a pair of coil cores arranged on both sides thereof and having coils wound thereon respectively;
a magnet connected to the pair of coil cores having the wound coils and allowing the coil cores to be polarized as a north pole and a south pole respectively; and
a shielding member formed at a passing portion of the magnetic flux between the pair of the coil cores having the coils arranged on both sides thereof, wherein the magnetic flux is repeatedly opened and blocked through a repeated motion of the shielding member to bring about a change of a magnetic field, whereby generating induced electricity.

2. A magnetic flux switching type electric generator using a shielding member as a permanent magnet comprising:
a pair of coil cores arranged on both sides thereof and having coils wound thereon respectively;
a magnet connected to the pair of coil cores having the wound coils and allowing the coil cores to be polarized as a north pole and a south pole respectively;
at least one shielding member formed at a passing portion of the magnetic flux between the pair of the coil cores having the coils for polarizing the north or south poles respectively; and
ferrite members located between the shielding members and continuously connected to the magnet, wherein the magnetic flux is repeatedly opened and blocked through a repeated motion of the shielding member to bring about a change of a magnetic field, whereby generating induced electricity.

3. A magnetic flux switching type electric generator using a shielding member as a permanent magnet comprising:
a saw-toothed rotating magnetic body;
a plurality of coil cores arranged along a peripheral of the saw-toothed rotating magnetic body having upper and lower coils wound thereon respectively; and
a magnet connected to the plurality of the coil cores having the wound coils and allowing the upper and lower coils to be polarized as a north pole and a south pole respectively, wherein a magnetic flux is repeatedly opened and blocked through a revolution of the saw-toothed rotating magnetic body to bring about a change of a magnetic field, whereby generating induced electricity.

4. A magnetic flux switching type electric generator using a shielding member as a permanent magnet as claimed in claim 1, wherein the shielding member is a saw-toothed rotating magnetic body and the rotating magnetic body is rotated, so that the magnetic flux is repeatedly opened and blocked through a repeated motion thereof to bring about the change of the magnetic field, whereby generating induced electricity.

5. A magnetic flux switching type electric generator using a shielding member as a permanent magnet as claimed in claim 1, wherein the shielding member is a bisymmetry magnetic body of a bar type and the magnetic flux is repeatedly opened and blocked through a repeated motion of the bisymmetry magnetic body of the bar type to bring about the change of the magnetic field, whereby generating induced electricity.

6. A magnetic flux switching type electric generator using a shielding member as a permanent magnet as claimed in claim 4, wherein the rotating magnetic body comprises a nonmetal circular plate having a rotating axis and a plurality of saw-toothed portions formed at a circumference of the nonmetal circular plate and having a N-polar upper portion and a S-polar lower portion thereof or a S-polar upper portion and a N-polar lower portion thereof.

7. A magnetic flux switching type electric generator using a shielding member as a permanent magnet as claimed in claim 4, wherein the rotating magnetic body comprises a nonmetal circular plate having a rotating axis, a plurality of saw-toothed portions formed at a circumference of the nonmetal circular plate and having a N-polar upper portion and a S-polar lower portion thereof or a S-polar upper portion and a N-polar lower portion thereof, and a plurality of magnetic bodies inserted into empty spaces between the saw teeth and having another S-polar upper portion and N-polar lower portion thereof corresponding to the N-polar upper portion and S-polar lower portion of the saw-toothed portions or another N-polar upper portion and S-polar lower portion thereof corresponding to the S-polar upper portion and N-polar lower portion of the saw-toothed portions.

8. A magnetic flux switching type electric generator using a shielding member as a permanent magnet as claimed in claim 4, wherein the rotating magnetic body comprises a nonmetal circular plate having a rotating axis, a plurality of saw-toothed portions formed at the circumference of the nonmetal circular plate and having a N-polar upper portion and a S-polar lower portion thereof or a S-polar upper portion and a N-polar lower portion thereof, and a plurality of ferrites or cores inserted into empty spaces between the saw teeth, whereby the flux of the magnetic force thereof can be increased.

9. A magnetic flux switching type electric generator using a shielding member as a permanent magnet as claimed in claim 3, wherein where the number of the coil cores having the wound coils is an even number, the number of the saw teeth formed at the peripheral of the saw-toothed rotating magnetic body is an odd number.

10. A magnetic flux switching type electric generator using a shielding member as a permanent magnet as claimed in claim 3, wherein the rotating magnetic body comprises a nonmetal circular plate having a rotating axis and a plurality of saw-toothed portions formed at a circumference of the nonmetal circular plate and having a N-polar upper portion and a S-polar lower portion thereof or a S-polar upper portion and a N-polar lower portion thereof, a N-polar portion of the magnet being located at an upper portion thereof in case of the N-polar upper portion and S-polar lower portion of the saw-toothed portion and a S-polar portion of the magnet being located at the upper portion thereof in case of the S-polar upper portion and the N-polar lower portion of the saw-toothed portion.

11. A magnetic flux switching type electric generator using a shielding member as a permanent magnet as claimed in claim 2, wherein the shielding member is a saw-toothed rotating magnetic body and the rotating magnetic body is rotated, so that the magnetic flux is repeatedly opened and blocked through a repeated motion thereof to bring about the change of the magnetic field, whereby generating induced electricity.

12. A magnetic flux switching type electric generator using a shielding member as a permanent magnet as claimed in claim 2, wherein the shielding member is a bisymmetry magnetic body of a bar type and the magnetic flux is repeatedly opened and blocked through a repeated motion of the bisymmetry magnetic body of the bar type to bring about the change of the magnetic field, whereby generating induced electricity.

13. A magnetic flux switching type electric generator using a shielding member as a permanent magnet as claimed in claim 11, wherein the rotating magnetic body comprises a nonmetal circular plate having a rotating axis and a plurality of saw-toothed portions formed at a circumference of the nonmetal circular plate and having a N-polar upper portion and a S-polar lower portion thereof or a S-polar upper portion and a N-polar lower portion thereof.

14. A magnetic flux switching type electric generator using a shielding member as a permanent magnet as claimed in claim 11, wherein the rotating magnetic body comprises a nonmetal circular plate having a rotating axis, a plurality of saw-toothed portions formed at a circumference of the nonmetal circular plate and having a N-polar upper portion and a S-polar lower portion thereof or a S-polar upper portion and a N-polar lower portion thereof, and a plurality of magnetic bodies inserted into empty spaces between the saw teeth and having another S-polar upper portion and N-polar lower portion thereof corresponding to the N-polar upper portion and S-polar lower portion of the saw-toothed portions or another N-polar upper portion and S-polar lower portion thereof corresponding to the S-polar upper portion and N-polar lower portion of the saw-toothed portions.

15. A magnetic flux switching type electric generator using a shielding member as a permanent magnet as claimed in claim 11, wherein the rotating magnetic body comprises a nonmetal circular plate having a rotating axis, a plurality of saw-toothed portions formed at the circumference of the nonmetal circular plate and having a N-polar upper portion and a S-polar lower portion thereof or a S-polar upper portion and a N-polar lower portion thereof, and a plurality of ferrites or cores inserted into empty spaces between the saw teeth, whereby the flux of the magnetic force thereof can be increased.
